(19) United States
(12) Patent Application Publication
(10) Pub. No.: US 2008/0005005 A1
(43) Pub. Date: Jan. 3, 2008

(54) Hedge Fund Liquidity and Redemption Management System

(76) Inventor: Serge BILLIEUX, Geneva (CH)

Correspondence Address: MOETTELI & ASSOCIATES SARL, ST. LEONHARDSTRASSE 4, ST. GALLEN, CH-9000, CH

(21) Appl. No.: 11/767,503

(22) Filed: Jun. 23, 2007

Related U.S. Application Data
(63) Continuation-in-part of application No. 11/766,648, filed on Jun. 21, 2007.
(60) Provisional application No. 60/805,711, filed on Jun. 23, 2006.
(60) Provisional application No. 60/825,548, filed on Sep. 13, 2006.

(51) Int. Cl. G06Q 40/00

(52) U.S. Cl. 705/36 R

(57) ABSTRACT

A system is disclosed for managing and processing the complex, diverse and unstructured fund liquidity and redemption related data of hedge funds into an organized data structure database compatible with a presentation in a generic output structure format that is easily digested and manipulated. A computer system runs a generic redemption plan (GRP) application which enables the computer system to receive and process diverse and unstructured fund liquidity and redemption related data into generic fund data for storage and access via a management system database. The term GRP is new to the industry and is used herein as a term of art referring to the present generic redemption plan. The GRP uses a hierarchical set of GUIs, the user can input raw data, view the processed (“genericized”) data, selectively perform a redemption analysis process using as factors data derived from the input of selected fund management parameters, the analysis result being communicated to the generic structure format and presented on an output means to the user.

The present application is a continuation-in-part of U.S. patent application Ser. No. 11/766648 (filed 21 Jun. 2007), and claims the benefit of prior filed U.S. Provisional Patent Applications Ser. Nos. 60/805711 (filed 23 Jun. 2006) and 60/825,548 9 (filed 13 Sep. 2006), to which applications the present application is a regular US utility patent application, and which prior application are incorporated herein by reference.

### FIELD OF THE INVENTION

The present invention is in the field of financial data processing involving methods and systems for structuring complex hedge funds' redemption rights by offering a generic description mechanism. This makes it now possible to analyze the liquidity of the portfolio of a fund of funds rapidly and precisely.

### BACKGROUND

A Hedge Fund is an investment vehicle usually used by wealthy individuals and institutions. These funds are domiciled offshore and can therefore use risk-adjusted strategies that are unavailable to mutual funds, such as short selling, leverage and all available derivatives. Their on-shore activities are restricted by law to a limited number of investors per fund (e.g., no more than a hundred investors). As a result, hedge funds tend to set very high minimum investment amounts, ranging anywhere from $250,000 to over $10 millions. Hedge funds have provided to their investors over the last 25 years returns in excess of traditional investments like stocks and bonds. This has attracted an ever growing number of interested potential investor. Therefore, where a traditional fund needs to spend money on marketing to raise assets, the hedge fund manager can choose his clients and filter them out by imposing ever more demanding conditions: higher fees, less liquidity, less transparency, etc. Funds of hedge funds have developed over recent years to diversify the hedge funds manager's risk, the strategy risk and decrease the minimum investment amount by pooling investors.

In the hedge fund field, liquidity usually means how fast a portfolio can be turned into cash. For a portfolio of stocks it could be estimated by a weighted average of the daily volume of each stock in the portfolio. The market is telling the number of days that one will need to liquidate his portfolio without disturbing the market prices too much. As far as a portfolio invested in hedge funds' shares is concerned, liquidity is subtly different in meaning. Because of the relationship we explained between the manager and its clients, the liquidity relates to the set of opportunities that an investor (typically a portfolio manager of a fund of funds) is offered to redeem (cash out) from any of these hedge funds. The managers of these hedge funds are in a position to dictate to investors the number of months, sometimes years, it will take for them to get all their investment back.

A particular fund's redemption conditions are described in the prospectus of the fund and are accepted in advance as a condition to be able to invest in this fund. Over time these advance conditions have increased in complexity. With the first hedge funds in the 1980's, an investor could typically expect a one year lock-up (special commitment period) and a monthly redemption frequency with the assumption that he would then be able to redeem 100% of his investment at once. Today, redemption conditions take many pages to be described in a prospectus, with the investor's rights broken down into various points in time with many conditions.

The present complexity of the redemption conditions is a problem source for a fund manager. It can easily take several hours of work for a senior back-office employee to extract from a fund's prospectus the actual detailed information describing these redemption conditions. Also, the life cycle of an average hedge fund is becoming shorter, and the number of new hedge funds is going up. This leads to an ever growing number of prospectuses flowing into the back-office of the banks with a higher and higher risk to miss a redemption opportunity for clients.

Today substantially all banks only put this critical information in text fields which are unstructured by nature. This means that any time one wants to use this information, he will have to read it again. A structured way of containing this information would make it possible to process this information automatically. This is the very purpose of this invention.

### Glossary

Capacity: Whether expressed in absolute or in relative term, the capacity of a fund is the optimal size it “should” have. Absolute capacity is referring to that. Relative capacity is the remaining/relative capacity between current size of the fund and absolute capacity.

Current Status: This field can obviously have many different meaning in general. In this context of hedge fund liquidity analysis, it tells whether the fund is still open to additional investment (“Open”) or closed to additional investment (“Closed”). One should remember that the hedge fund manager has most of his own money into the fund and want to optimize future potential return. As his reputation is good he can raise a lot of money. Too much would dilute the potential returns. Which is the very reason why the manager stops accepting new investment in his fund at some point in time. Quite often, an intermediate status is observed: “soft-closed” meaning that only current investors can add money to the fund.

Dates: One of the purpose of GRP tables are to make it possible to automatically forecast the many cash-flows a portfolio of funds will get when redeeming all his funds. Each of these cash-flows are characterized by a (1) Action_Date: the deadline before which the redemption request must be sent to the fund administrator, (2) NAV_Date: the date as of which the NAV that will be used to calculate the redemption payment will be calculated, (3) a Value_Date: the date as of which it will be sent (the money).

Exit fees: These fee are similar in essence to the bid/ask spread for a stock. They are retained from redemption payment and paid to the management company of the fund to cover transaction or any related costs.

Fund of hedge funds: A fund of funds invests in a number of hedge funds and hedge fund strategies that generally are uncorrelated to each other. A fund of hedge funds typically holds between 5 and 100 different funds.

Gate: Maximum percentage that one fund can redeem to investor as a percentage of its asset. This number is described and agreed in advance in the prospectus. A fund managing 100 mios with a 10% gate will only allow 10 mios to be redeemed at once. If only one investor redeems his position of 8 mios, he will get it all back. If the aggregated assets presented for redemption amount to 30 mios, all redeeming investor will only get 33.33% of their investment back.

GUI: A graphical user interface (or GUI) is a method of a user interacting with a computer through manipulation of graphical images in addition to text.

Hedge fund: Historically the first hedge funds appeared with the first derivatives in the late 1950's. But they really grew in number and size when IT (IBM, Microsoft, Oracle . . . ) started to enable them to connect electronically to financial market and manage information (the true raw material of finance) with a small efficient team. The most famous one started their business in the early 1980's and implemented more and more sophisticated strategies to produce sometimes very consistent and over average returns to their happy few investors. This industry has now moved to a more mature mode where many figures have grown tremendously with the task of finding the best managers and avoiding the worst ones being more and more difficult. A hedge fund is an investment fund domiciled offshore implementing non-traditional investment strategies to achieve absolute return with a management fee structure sharing the performance with the manager, typically 20%.

Lock-up (period): Special period during which a new investor can not redeem from a fund even so other more senior investors might be able to do so. Even a new investment of a senior investor will be subject to such a lock-up period.

Minimum Investment: To limit the number of investors, hedge fund managers have defined in the prospectus of their fund the minimum amount of money that one investor must invest initially to qualify for a valid subscription. They often also defined the minimum additional investment so that a transaction is not dealing with a too “small” amount. These two numbers are often subject to negotiation. Therefore, managers have also defined their absolute minimum value. When redeeming, the manager allow himself to refuse to keep a too small of a remaining investment, hence the “Minimum retained investment.”

NAV: Net asset value per share—the market value of a fund share. Equals the closing market value of all securities within a portfolio plus all other assets such as cash, subtracting all liabilities (including fees and expenses), then dividing the result by the total number of shares outstanding.

Payment Schedule: When the NAV of a given valid subscription/redemption date is passed, the redeeming investor no longer run any market risk, but the NAV may need quite some time to be calculated as the underlying portfolio can be very complex. Therefore, the prospectus often define one or two partial payment(s) to the investor: one on the basis of an estimated valuation with a margin (90% of the estimated value) and a second one which equals the remaining assets based on a final and/or and audited valuation.

Penalties: Unlike exit fees, the penalties are meant to protect remaining investors from the unplanned exit of a given investor, which might—by forcing the manager to sell some positions at depreciated prices—pull the value of the portfolio down. They are retained from the redemption payment and paid to the portfolio of the fund.

Raw data: Unstructured fund specific data extracted from fund's prospectus.

Redemption: Liquidation of interests in an investment fund.

Redemption fees: (see Exit fees).

Redemption Frequency: Frequency defining the days when an authorized investor can redeem from the fund. (for example: monthly, quarterly, yearly, etc.)

Redemption penalties: Fees charged upon an un-planned voluntary redemption from an investment vehicle. See Penalties.

Redemption notice period: Period that must separate the redemption request from the valuation point. This means that it is a minimum time to respect for sending the request generally in writing in order for the request to be valid. If one seeks to redeem as of December 31with a notice period of 2 months, then the redemption request must be received by the administrator of the fund no later than the closing of October 31

Subscription Frequency: Frequency defining all the days in a year when a authorized investor can subscribe to the fund.

### SUMMARY OF THE INVENTION

The present hedge fund liquidity and redemption management system is a tool for fund of funds managers. It takes complex and disparate fund redemption related data from multiple different sources and restructures it into an easily mentally digestible and generic format to facilitate the liquidity assessment and redemption decision making processes. The format is generic in that, no matter how unstructured and different the formatting of the subject data was at its source, the present system presents the data in a format that is common to all restructured data from all of the different data sources. The present system accomplishes this object by generating a structured repository of redemption related information that was initially available only as unstructured data. This data is then presented in a “generic redemption plan” pane (display).

A generic redemption plan (GRP) is an interactive tabular output of the system presented to a user as a GUI interface on an I/O display device. The generic feature of the GRP output table is important. Because there can be a large number of individual hedge funds in a fund of funds portfolio (each of which being complex in its own right), it is of great benefit to have a management tool that makes it possible to structure in a generic way, the pertinent information relating to redemption conditions of each of the different managed funds. The term GRP is a new term presented to the industry and is used herein as a term of art to refer to the present generic redemption plan.

The present hedge fund liquidity and redemption management system is adapted for processing and converting complex and diverse unstructured fund redemption related data and outputting processed data in a generic structure that is easy to mentally digest. The present system comprises a computer system having data input and output means, the computer system in communication with a software instruction set including a generic redemption plan application. The instruction set is resident in a data storage media accessible by and in process communication with the computer system. The generic redemption plan application of the instruction set is adapted to enable the computer system to receive and to process diverse and unstructured fund liquidity and redemption related data into processed fund data, and to store the processed fund data in a fund management system database. Additionally, the generic redemption plan application is adapted to permit the selective communication of the processed fund data for presentation in a generic output structure format in response to management parameter selections and commands input into the system by a user.

The management system database can be resident in the same or in a second data storage media, which is accessible by and in functional communication with the computer system. The management system database is for storing the processed fund data for access and use by the management system. A data output device is in functional communication with the computer system. The output device receives and presents to the user in the generic structure format the results of generic redemption plan application's operations on the user selected processed fund data.

### BRIEF DESCRIPTION OF THE DRAWINGS

FIG. 1 is a system overview showing a block diagram presenting an overview of the major hardware components of the present redemption management system and their interrelationships.

FIG. 2 is a block diagram representing an overview of the process of the present invention.

FIG. 3 is a representation of a GUI screen of a preferred embodiment of the present system 10, the screen having several interactive aspects. This screen is a liquidity definition screen describing the conditions to subscribe into or redeem from a fund.

FIGS. 3A to 3C are (A) a block diagram showing a step wherein the user may select the mode from a default initial screen wherein the “liquidity” features of the screen are presented (i.e., “liquidity” tab), and the user having two selectable states of the Liquidity Tab screen: (B) the automatic/simple mode and (C) the manual/advanced mode.

FIG. 4 illustrates a GUI screen used to input and display some general information relating to a fund. Most of this information is defined to be used in a liquidity analysis process.

FIG. 5 illustrates a GUI screen used to input and display textual comments (unstructured data) relating to a specific subject and a specific field of the liquidity definition screen.

FIG. 6 illustrates a GUI screen used to input and display information relating to the ID of the same object for use to synchronize data with other databases if necessary.

FIGS. 7A and 7B illustrate in the automatic/simple mode, the automatic generation of a generic redemption plan table using only redemption frequency and lockup inputs.

FIGS. 8A and 8B illustrate in the automatic/simple mode the automatic generation of a generic redemption plan table in the simple mode using both redemption frequency and Notice period inputs.

FIG. 9 is a GUI display of the Automatic mode for the fund illustrated, wherein the automatically generated GRP table indicates when the lock-up is soften by an option to pay a penalty for redemption.

FIGS. 10A and 10B are GUI displays illustrating use of the a GUI toggle button to switch between the two Liquidity modes (Automatic and Manual); with the Manual or Advanced mode GUI features being displayed in this figure.

FIGS. 11A and 11B are GUI displays illustrating the “drag and drop” process of the present system for creating and/or editing GRP tables. These figures illustrate the way the user can drag & drop certain fields from the redemption portion of the manual mode display into the GRP pane to create or edit one or more GRP table(s), wherein (A) is dragged but not dropped; (B) is dropped as a new Section in the selected GRP table.

FIGS. 12A and 12B are flow diagrams illustrating the “drag-and-drop” process of the present invention.

FIGS. 13A to 13G are GUI displays of the Advanced/Manual mode illustrating the variety of features that can be displayed in a GRP table.

FIGS. 14A and 14B illustrate how the data fields of the various parameters or characteristics of a fund's GRP tables can be edited in the present system.

FIGS. 15A to 15C illustrate the step-by-step analysis feature of the present system.

FIG. 16 is a graphical summary of a liquidity analysis.

FIG. 17 is a GUI display of an Analysis Report which makes it possible to launch a liquidity analysis on one or many portfolios of a fund of funds.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

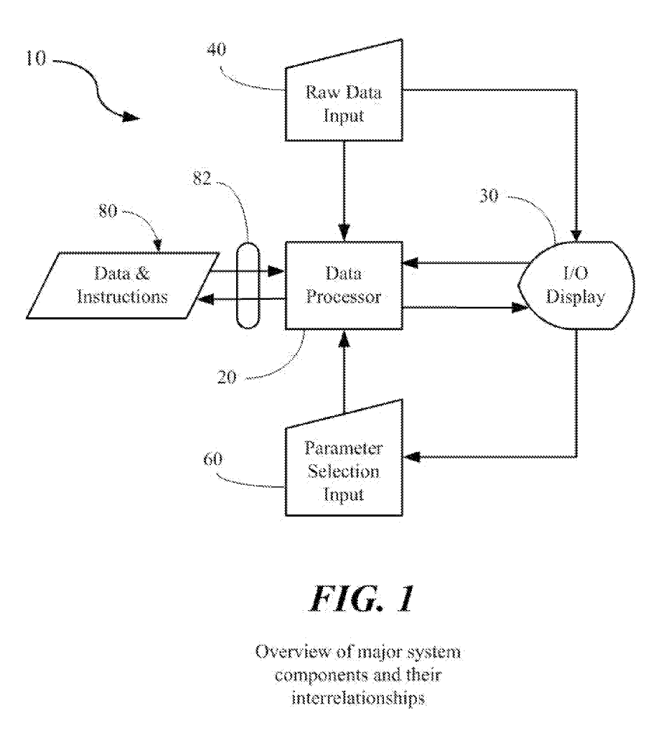

FIG. 1 is a block diagram presenting an overview of the major components of the present redemption management system 10. The system comprises a data processor 20, which in the embodiments illustrated was a personal computer configured with the usual peripheral devices, such as a printer, keyboard, mouse, etc. (not shown). A data processor of the present system anticipates any computer system personally useable by an end-user, and is not defined by or limited to a personal computer of a particular brand, manufacture or operating system, and includes workstations connected to a served network or to a mainframe. The system 10 included an I/O display device 30 in operative communication with the data processor 20. The I/O device 30 in the embodiments illustrated was a personal computer video display unit. Additionally, the present system 10 included a raw data input mechanism 40 and a parameter selection mechanism 60. Data and an instruction set 80 were stored on data processor 20 (a personal computer), but could have been stored elsewhere (e.g., an external data source) and accessed via an external data or device connection 82.

The objects of the present invention 10 are: to take the input of unstructured data from any hedge fund unstructured data source 14 amongst a large plurality of different unstructured hedge fund data sources 16, and to reorganize the disposition of the data to provide a generic structured data output 18 for the data from the various sources. The data input is unstructured in that the modality and formatting of the individual data sources 14 are not standardized across the field of the plurality of data sources 16. In one case, the data source may consist of a paper document hundreds of pages long, and the location and formatting of the data of interest to a fund manager in this case may have no common relationship to the location and formatting of the data of interest in any other paper document. Even a prospectus of a fund in electronic form is unlikely to have the data of interest to a fund manager in the structured in the same manner as that of another fund's electronic prospectus.

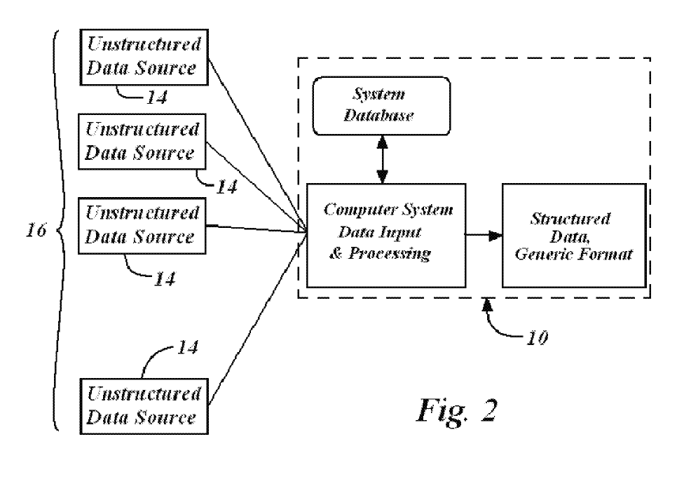

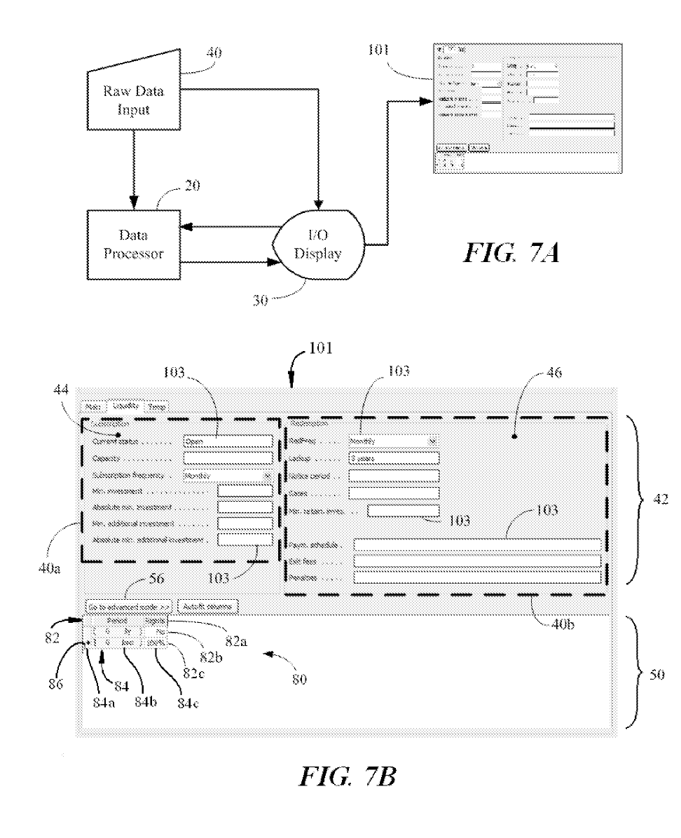

The structured data output 18 of the present system 10 is generic in that the “generic redemption plan” (GRP) 80 (see FIG. 7B) presentation of the structured data output 18 is standardized and has the same look, feel and functional features regardless of which of the funds 14 of the plurality of unstructured data sources 16 the data are derived from, no matter how different the separate funds are initially. FIG. 2 is a block diagram generally illustrating the “generitization” process of the present system 10. Data from an unstructured data source 14 of interest to a fund manager is input into the system 10. Within the system 10, the parameters of interest are (re)structured to provide generic structured data output 18.

As noted above, a further object of the present invention is to provide the restructured data as output in a generic format 18 that is presented to a user as an interactive GUI interface on an I/O display device. The interactive feature allows a user (e.g., a fund of funds manager) not only to create a GRP 80 table, but also to stipulate different redemption parameters and have the GRP 80 provide time dependent specific liquidity conditions of a fund.

A fund is described by its list of characteristics. This list initially is simply flat, but different software applications choose to present these characteristics in specific ways. Here, the TABs are used to put these characteristics in “focus” groups because they are related to the same subject about a fund. “Main” is for general info, “Liquidity” is related to conditions to subscribe into or redeem from the fund, “External Key” is where the ID of the same object are kept to synchronize data if necessary, “Comments” are text (unstructured data) related to a specific subject and actually a specific field of the liquidity section. “Standard/traditional Data” will initially either be input manually or through a standard import mechanism.

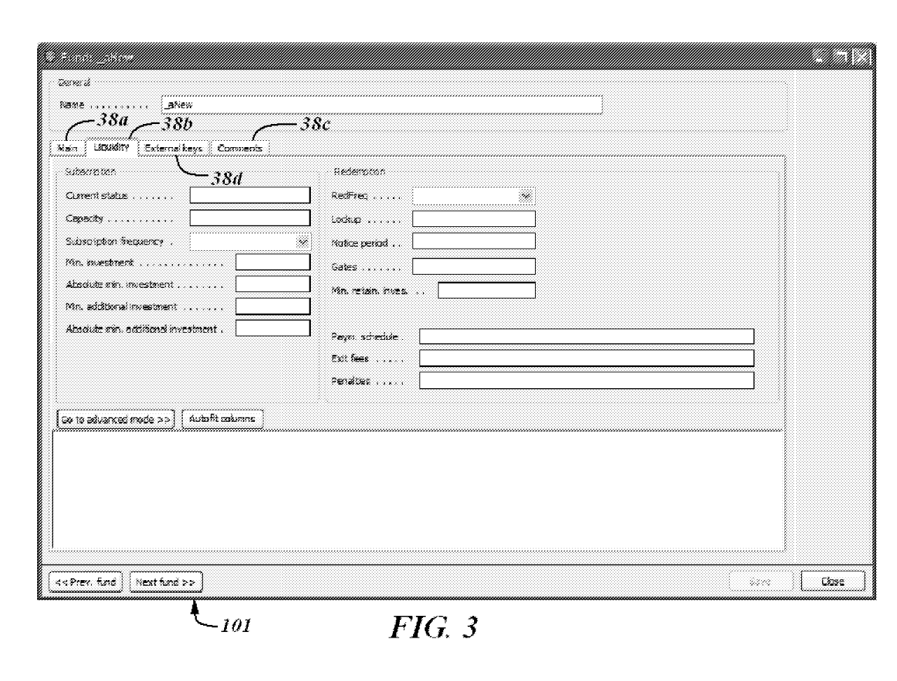

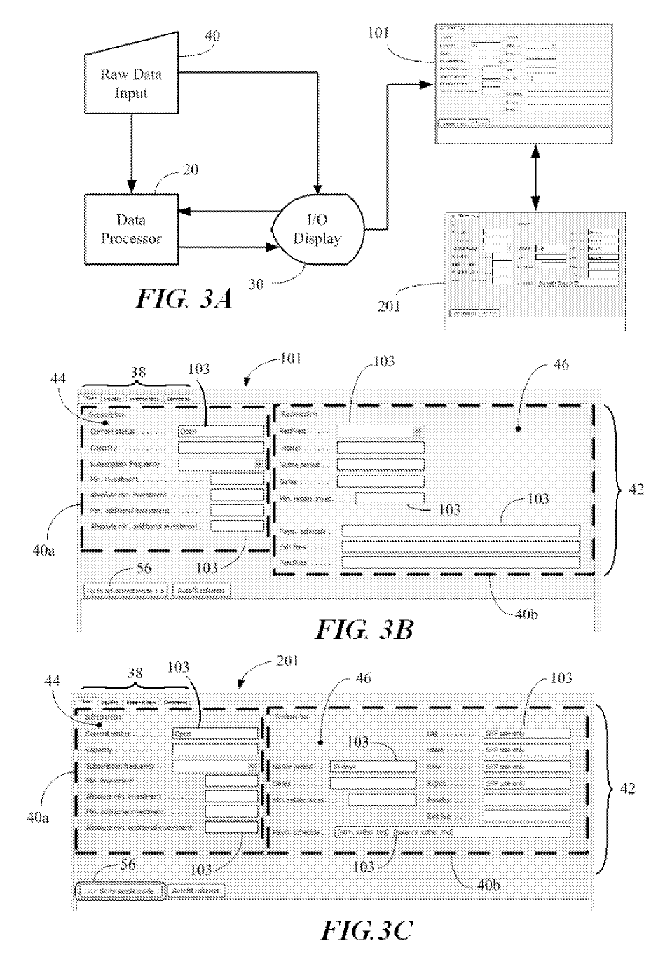

In a preferred embodiment, the present system 10 was practiced as a set of interactive graphic user interfaces (GUIs) that facilitated a user accomplishing various operations that comprise the system 10, and to present structured data to the user in a standardized format for assimilation and/or further processing. These processes include: inputting fund data, manipulating parameters, and displaying liquidity analyses. Aspects of a process may be dealt with in one or more GUIs or different aspects of multiple processes may be dealt with together in a GUI. For example, FIG. 3 shows a GUI screen 101 of a preferred embodiment of the present system 10. This screen has several interactive aspects, as can any of the GUIs of the present system 10.

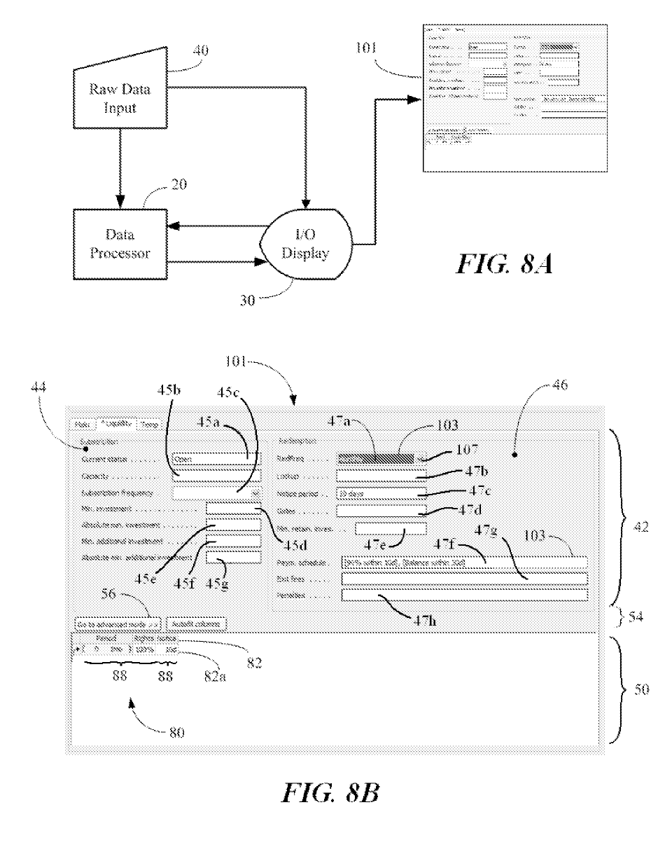

The present hedge fund liquidity and redemption management system 10 may be described and understood by the process of its use. As illustrated in FIGS. 3A and 3B, in a first step of a process of using the present redemption management system 10, upon initializing, a first GUI interface screen is presented to the user. In the preferred embodiment illustrated herein, this first GUI interface screen is the “Simple” or “Automatic” Mode interface 101. The top section 42 of the simple mode screen 101 comprises one or more raw data input mechanisms 40, wherein general fund data of a particular individual fund may be entered into appropriate fields selected by the user. More specifically, the “Subscription” portion 44 of the top section 42 is a raw data input mechanism 40a for inputting raw fund data specific to the fields 103 listed in the Subscription portion 44 of the simple mode screen 101. Another portion of the top section 42 of the simple mode interface screen 101 is another raw data input mechanism 40b for inputting raw fund data specific to the fields 103 listed in the Redemption portion 46 in the simple mode (screen 101). The different features illustrated in FIG. 3C will be explained below. In the preferred embodiment illustrated in FIGS. 3B and 8B, the Subscription portion 44 included data input fields of: Current status 45a; Capacity 45b; Subscription frequency 45c; Minimum investment 45d; Absolute minimum investment 45e; Minimum additional investment 45f; and Absolute minimum additional investment 45g. The Redemption portion 46 included data input fields of: Redemption frequency 47a; Lock-up 47b; Notice period 47c; Gate 47d; Minimum retained investment 47e; Payment schedule 47f; Exit fees 47g; and Penalties 47h.

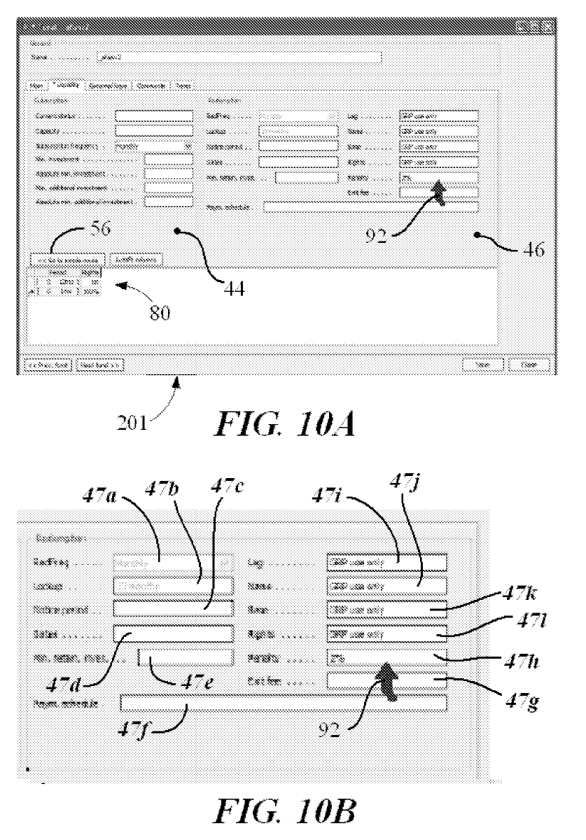

When the Manual or Advanced mode interface 201 is displayed, the formatting of the Redemption portion 46 is modified with some of the data fields 103 displayed on the Automatic mode interface 101 being omitted or made inactive and others being added. For example, see FIG. 10, where the Subscription portion 44 is similar to that of the Automatic interface 101, but the Redemption portion 46 is changed. Specifically, in the embodiment illustrated in FIG. 10, the RedFreq 47a and Lockup 47b fields are “grayed out” and are not editable. Other fields 103 of the Automatic interface 101 Redemption portion 46 are also displayed on the manual interface 201 Redemption portion 46. New data fields 103 are also added on the manual interface 201 Redemption portion 46. These are data fields for: Lag 47i; Name 47j; Base 47k; and Rights 47l.

The top portion 42 of the automatic mode screen 101 displays only the usual/traditional data fields of a hedge fund relating to the right to subscribe in and to redeem from such a fund. For the embodiment illustrated, these data fields for subscribing include: Current status, Capacity, Subscription frequency, Minimum investment, Absolute minimum investment, Additional investment, and Absolute additional investment. For redeeming, these data fields include: Redemption frequency, Lock-up, Notice period, Gate, Minimum retained investment, Payment schedule, Exit fees, and Penalties. Data fields for other attributes might be included or substituted for one or two data types in these lists. The default screen illustrated is the automatic mode/stage of the “Liquidity” screen tab 38b.

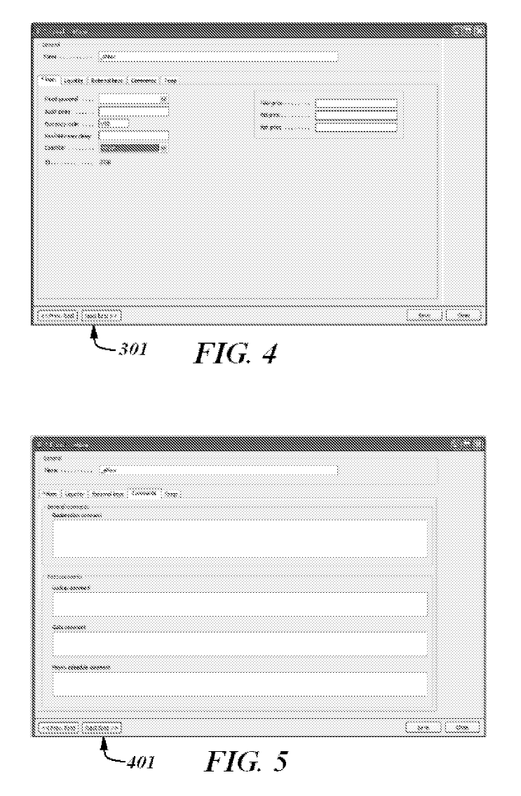

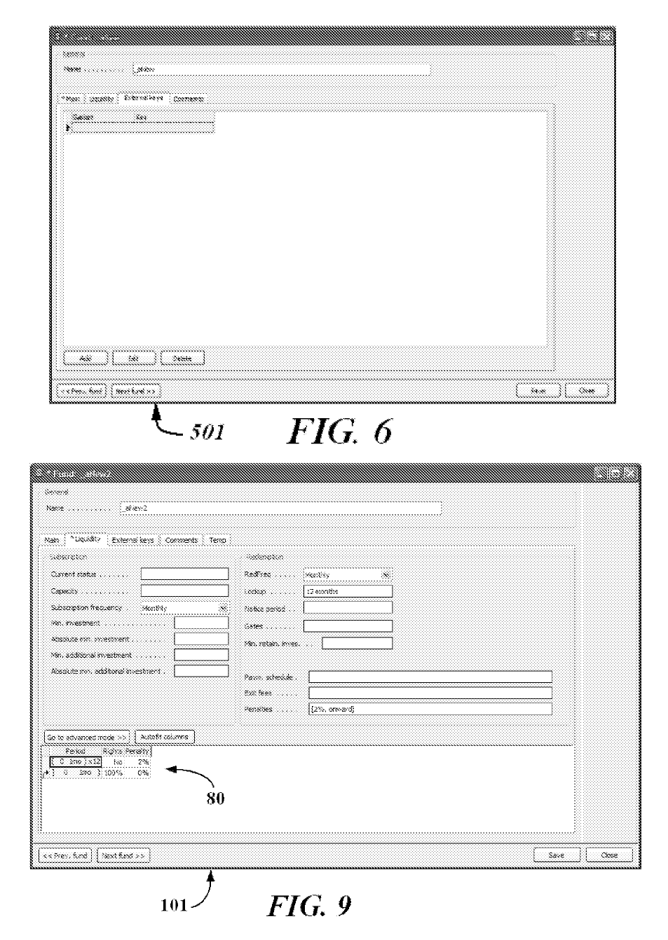

In the embodiment illustrated, the automatic or simple mode screen 101 was the default GUI interface initially presented to the user. Once this screen was opened, the user could select a toggle button that called up a different state of this GUI interface: the advanced mode screen 201. Of course, the default initial GUI screen presented to a user is optional. Other GUI screens of the present invention 10 that the user can chose to display are selectable by activating link “Tab” 38 on the screen illustrated in FIGS. 3B and 3C. For example, the Main Tab 38a displays fund general information screen, which is used to input such data about a new fund or to edit existing fund general information, see FIG. 4. The Comments Tab 38c displays a screen (FIG. 5) for inputting and displaying textual “comments,” i.e., unstructured fund data of interest which is related to a specific subject and actually a specific field of the Liquidity Tab screen 38b. The External Key Tab 38d displays a screen (FIG. 6) for inputting and displaying the ID of the same object for use to synchronize data if necessary.

These ancillary screens enable the system 10 to import data from other databases that do not use the GRP approach. They contain unstructured data that will feed the Comments screen fields. External Keys feature is used in the traditional way to keep track of the corresponding object IDs in other databases.

Liquidity Tab Screen Operational States: Automatic (Simple) Mode

In the simple mode screen 101 of FIGS. 3A and 3B, the user only needs to input Redemption Frequency (RedFreq) data and the Lock-up period data (if any) into the appropriate windows to get an automatically generated GRP 80. In the example illustrated in FIGS. 7A and 7B, a redemption frequency “Monthly” was entered in the frequency data field 46a via a selection made using the RedFreq menu feature 107. A Lockup period of “3 years” was entered into the Lockup data window 46b. As illustrated in FIG. 7B, once sufficient data was entered into the appropriate data fields 103 of the Redemption portion 46 of the top section 42 of the simple mode screen 101, a GRP (generic redemption plan) table 80 was presented in the output section 50 of the screen 101. Note in FIG. 7B that the GRP table 80 has a heading line 82 reflecting the “Period” and the redemption “Rights” regarding the subject fund.

As in the embodiment illustrated, the GRP table 80 is comprised of rows 82 and columns 84. The top row or line 82a lists the column headings for the various columns 84. One or more adjacent columns 84 containing fields of related data make up a “section” of a GRP table 80. As a minimum, a GRP 80 has one section 88 (see FIG. 8B), which comprises a “Period” column 84b and a “Rights” column 84c. Other sections 88 may exist in the GRP table 80 and/or can be added. In the GRP table 80 illustrated, the “Period” column reflects, from top to bottom, cumulative time. That is, the top/first data line 82a of the GRP 80 indicates that from time zero (Investment/NAV date) to three years, there are no redemption rights available for the fund. The next line of the GRP indicates that after three years and one month, 100% redemption rights are offered by the fund. The “ [symbol] ” 86 is a “return” symbol, meaning that upon completion of the last step/line of the GRP table it cycles over and over again by returning to the indicated period in a cumulative way. Therefore, in the example, if the redemption opportunity is not taken during one cycle of the period, the next month there is another opportunity to redeem, and so on until redemption occurs.

In another example in FIGS. 8A and 8B of the simple mode screen 101 processes, the illustrated fund has RedFreq 46a of “Monthly,” has no Lockup period data 46b, and has a Notice period data 46c of “10 days.” As above, without doing more, once sufficient data is entered into the Redemption portion 46 of the simple mode screen 101, a GRP table 80 is presented in the output section 50 of the screen 101. In the embodiment illustrated, the top/first data line 82a of the GRP 80 indicates that after one month, 100% redemption rights are available in the fund, subject to a ten day notice period. The “ [symbol] ” 86 indicates that if the redemption opportunity is not taken (e.g., no or too late notification) during one cycle of the period, the next month there is another opportunity to redeem, and so on until a redemption occurs.

In the automatic mode the GRP is very simply derived from only two fields: redemption frequency and lock-up. No other fields need to be involved. However in an alternative embodiment, the automatic GRP may be created that includes analyses based on additional parameter fields, for example the field “penalty.” See FIG. 9. In FIG. 9, for the fund illustrated, the automatically generated GRP table 80 indicates when the lock-up is softened by an option to pay a penalty for redemption. Note that the Penalty value can be “factorized,” i.e., set to some value, and “de-factorized,” set to another (cycle or time dependent) value. The same may be accomplished with the Payment schedule, Gates, and Notice Period fields, for example.

Liquidity Tab Screen Operational States: Manual (Advanced) Mode

As shown in FIG. 8B, the Automatic or Simple mode screen 101 has a function/navigation section 54. Via a GUI link 56 in this section, a user can call up an alternative advanced/manual mode GUI 201 for presentation on the I/O display 30. The advanced or manual mode interface 201 (see FIG. 3C) is laid out in a manner similar to the simple/automatic mode interface 101. On switching to the Advance mode, the manual mode screen 201 is displayed. See FIG. 10. Note that any setting for the Redemption Frequency 47a and the Lockup period 47b are carried over into the manual mode interface 201, along with its GRP table 80.

Adding Fields to the GRP Table.

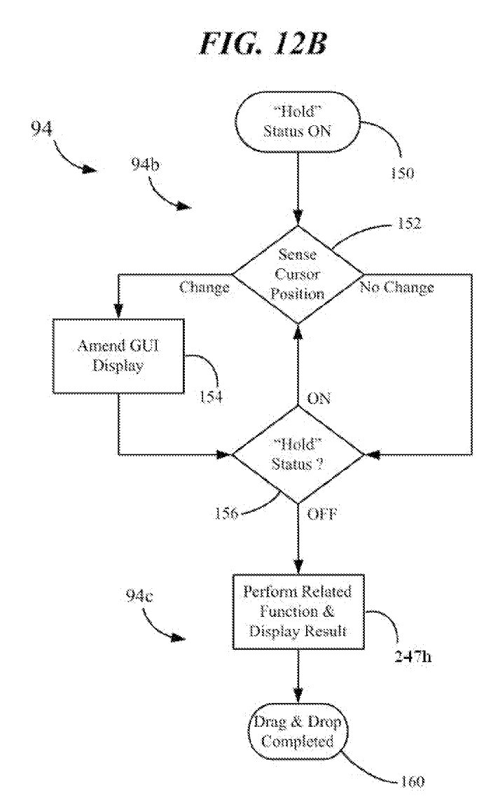

A GRP table 80 can be edited or a new GRP 80 can be created using the “pre-loaded” drag-and-drop feature 94 (see FIGS. 10A to 12B) of the present system 10. The drag and drop feature is “pre-loaded” in that on completion of the drag-and-drop action, the GUI will be amended to include display features specific to the parameter selected to drag-and-drop, and will be pre-loaded with whatever value is set for the parameter. As shown in FIG. 10, on the interface 201 a user selects the data field 103 of a parameter (the Penalty data field 47h in the illustration) to be added to the GRP 80 with a user interface device, such as a computer “mouse” (not shown) and screen cursor 92. Although the preferred embodiments illustrated utilized a computer mouse and screen cursor as the user interface device, other such interface devices are known to and selectable by one of skill in the art for practice in the present system 10. For example, a computer light pen may serve as a suitable user interface device. On selection, when the GUI display 201 senses the position of the cursor 92 as corresponding to a selectable location, the GUI highlights 134 the selection as a selection option availability indication 130 to let the user know that the field of the selection is in fact selectable. If the user merely “clicks” (hold status “Off” 138a, see FIG. 12A) to select the data field of the desired parameter—the Penalty data field 47h in the illustration, the user may edit the data in the field. In FIG. 10, the user had previously (in Automatic mode) edited the Penalty data field 47h, and the field is therefore pre-loaded with a non-default value.

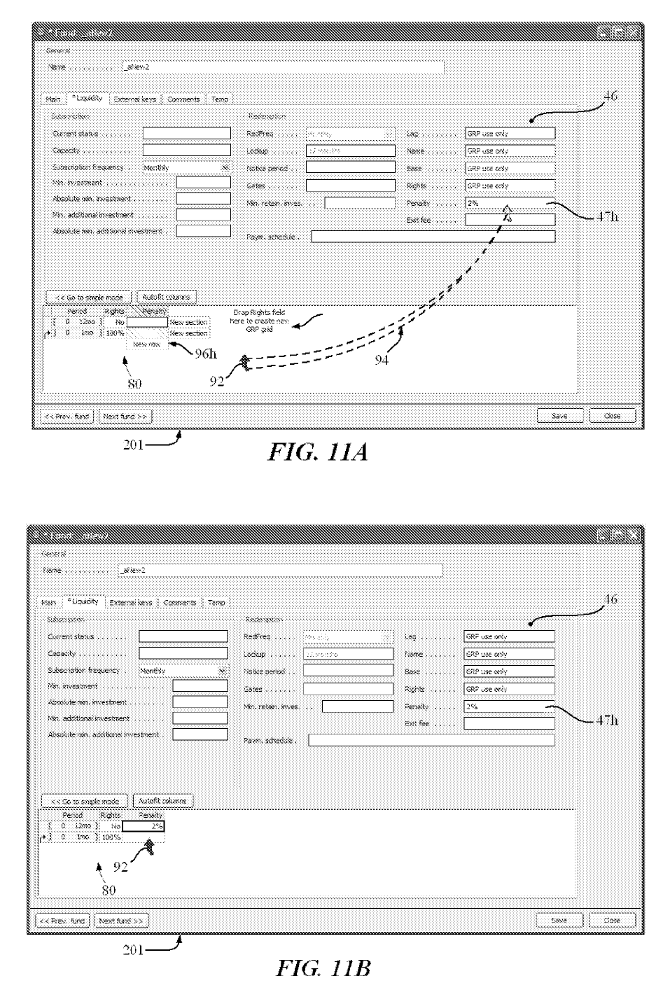

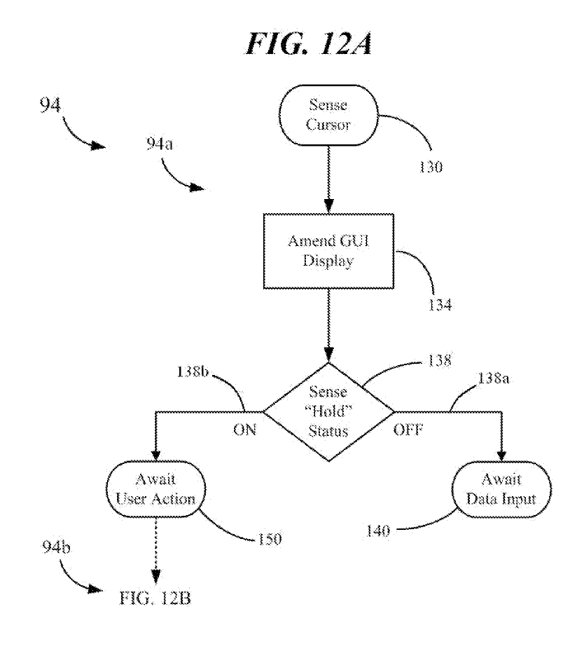

If the user performs a “click and hold” action (hold status “On” 138b, see FIG. 12A) on the redemption data field 103 of the desired parameter—the Penalty data field 47h in the illustration, the user may “drag” feature 94b of the process 94 of the selected field (if it has one) to indicate another location on the manual mode interface screen 201 at which to have the result of the function displayed. Specifically, in the embodiment illustrated, the user performs a click on, hold 138b to initiate the drag feature 94b of the drag-and-drop process 94 of the GRP penalty process 247h connected with the Penalty data field 47h, and to indicate where the result of the process is to be disposed in the output section 50 of the interface display 201, and to the GRP table 80. See FIG. 11A.

After the cursor 92 enters the output section 50 of the interface display 201, and approaches the GRP table 80, the selected process result 96h of the GRP penalty process 247h in this example, is displayed at a location indicated by the positioning of the cursor 92 by the user. An ancillary display 97 may also result from the activation of the process function 247 of a particular data field, such as the ancillary informational display 97 shown in FIG. 11A. Note: at this stage of the user's hold, drag and drop action 94, the “drag” part 94b of the operation has occurred, but the “drop” part 94c has not. So, the user is still performing the “drag and hold” part 94b. Therefore, the selected process result display 96h does not include any data, just the related data fields.

Before the user performs the “drop” part 94c of the drag, hold and drop action 94, the user has four options for the positioning of the cursor 92, so that when the drop part 94c of the action is performed, a specific desired result may be obtained. These options are: (1) to add a Row to the existing GRP; (2) to add a Section to an existing GRP; (3) to add a Field to an existing GRP; and (4) to add a New GRP to the output section 50 of the screen 201. In the example illustrated in FIG. 11B, a new Section was added to the existing GRP 80 in the output section 50. Note that when the drop part 94c of the hold, drag and drop action 94 is performed, the section is loaded with the pre-loaded value of the GRP data field 104 of the parameter that initiated the process function 247—the Penalty data field 47h in this example.

Editing GRP Table Field Values.

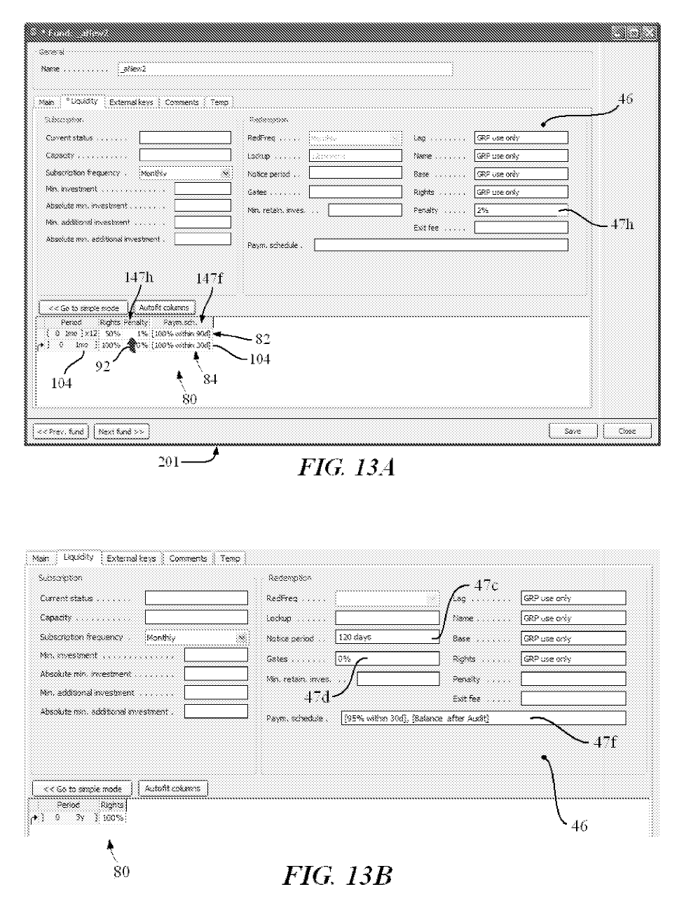

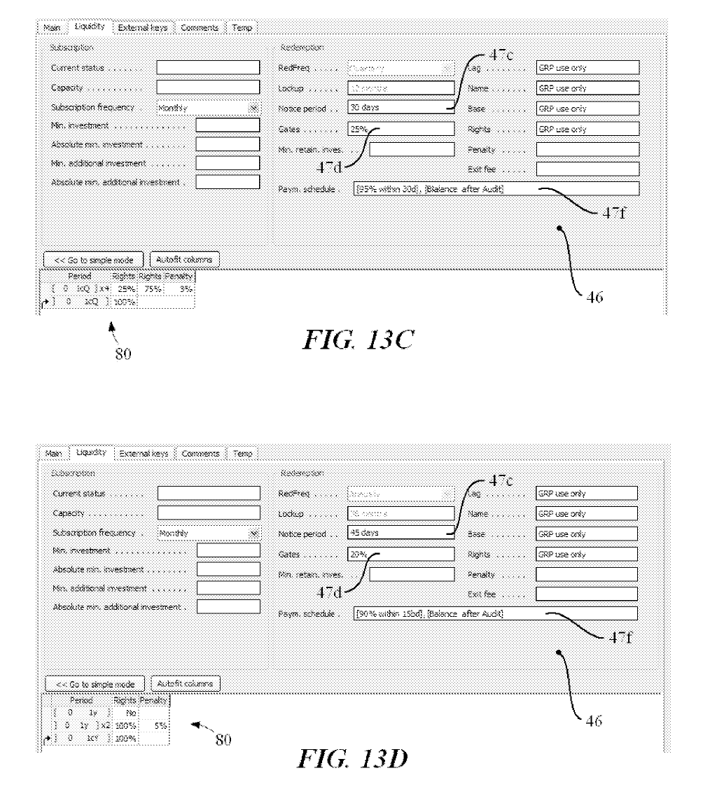

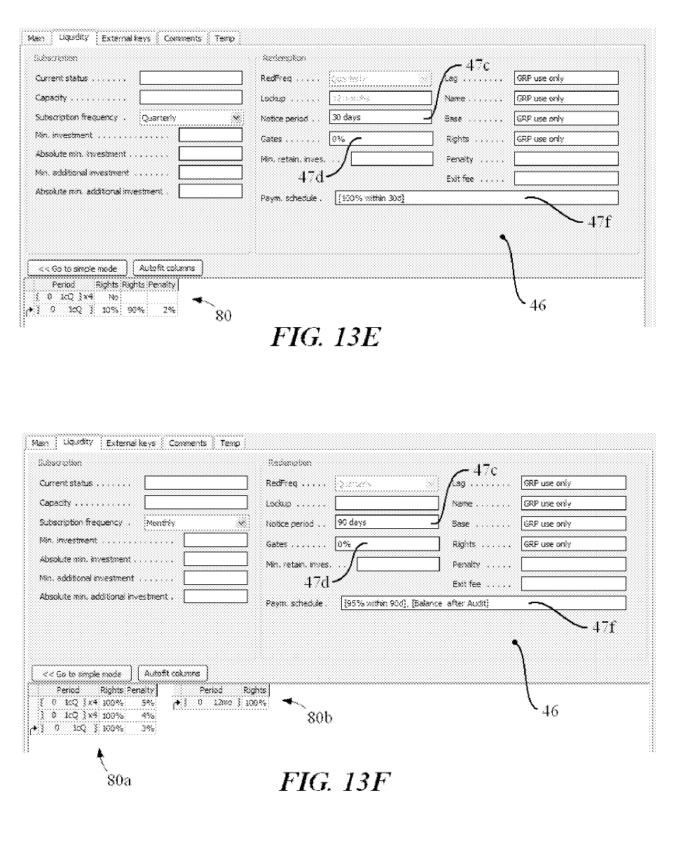

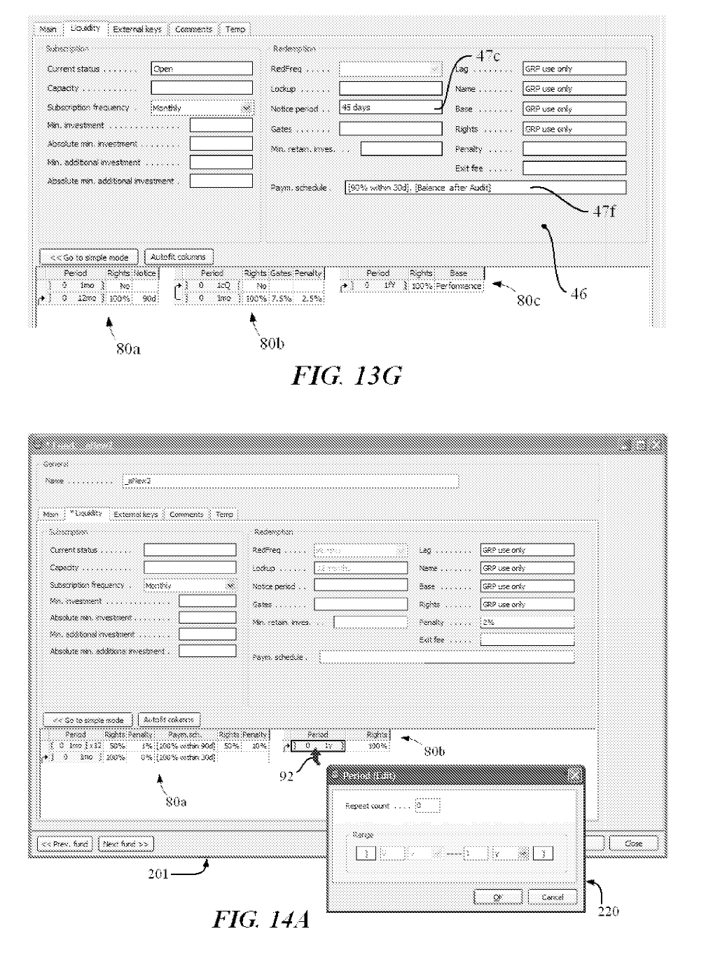

Either the existing or newly added GRP data fields 104 of a GRP 80 can be independently amended. As an example, FIG. 13A shows a GRP table 80 to which two columns 84 have been added: a Penalty section 147h and a Payment Schedule section 147f. Note that the value in the top field of the Penalty section 147h has been selected using the cursor 92 and the value set to: “1%,” as opposed to the pre-loaded value of “2%” shown in the Penalty data field 47h of the redemption section 46. In fact, the Penalty section 147h and Payment Schedule section 147f can have a different value for each Row (time range). FIGS. 13A to 13G are examples of various GRP tables 80 created and displayed using the drag-and-drop 94 and/or the editing feature of the present system 10 for existing funds.

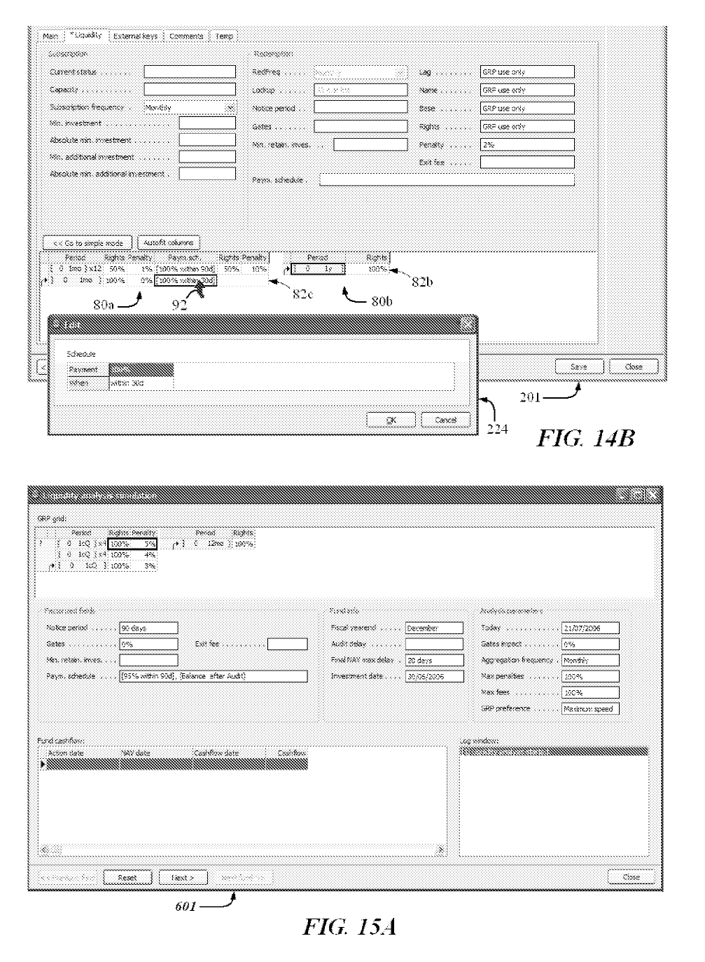

In FIG. 14A, a specific example of the editing feature used to edit the Period data field of a second GRP 80b is displayed in the output pane 50 of the display 201. In this example, the cursor is positioned on the period data field and “clicked.” This action calls up a Period edit display GUI 220. The user may now use the Period edit display to edit the Period data field of the second GRP table 80b. In a similar manner, as illustrated in FIG. 14B, the editing feature is used to edit the payment schedule data field of the second line 82c of the payment schedule section in the first GRP 80a.

Analysis Screen: Step-by-Step

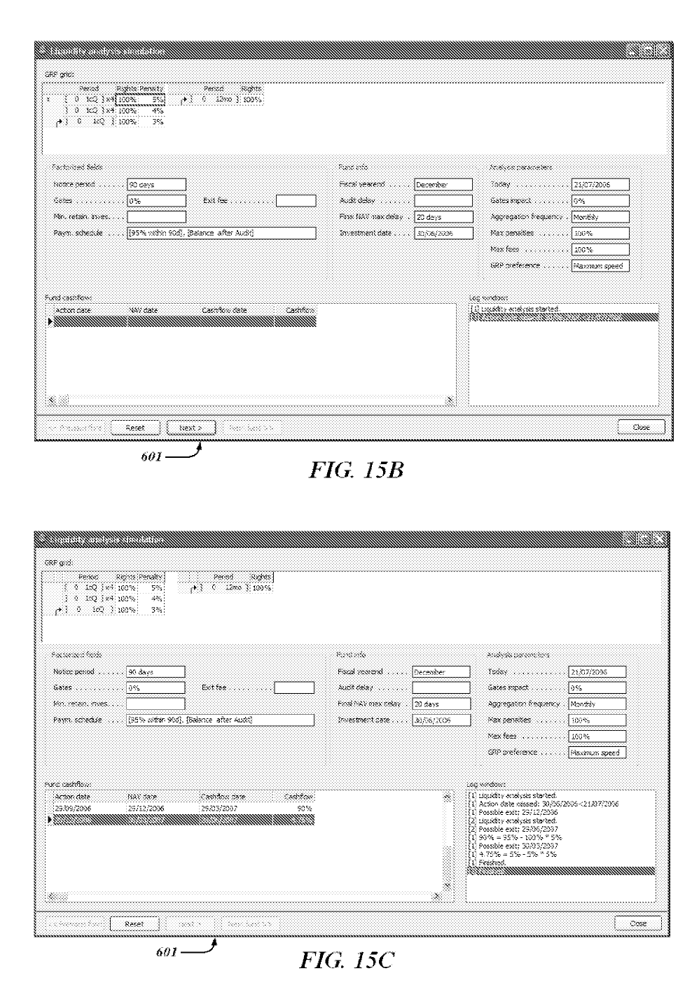

Once the GRP of a universe of hedge funds are defined in a structured way, a lot of new analysis can be performed. As GRP's are defining the conditions at which an investor can redeem from a fund, by spanning the future of the investment date with specific conditions for specific time ranges, it was necessary to make the system able to build trust in what it can do when most people are still spending a lot of time on doing it manually and with a lot of approximations. Therefore the system has been designed to show this way of working, which is scanning GRPs from investment date into the future for the first opportunity of redemption while respecting the various constraints. FIGS. 15A to 15C illustrate the step-by-step analysis feature of the present system 10. The step-by-step window is launched by a button from the main analytical window in the analysis section. It makes it possible to follow the way the analytical engine uses a GRP table 80 to forecast all the cash-flows defined with their NAV Date, Action Date, and Value Date. Depending on the preference of the portfolio manager as defined by these and certain other parameters of the analysis, the analytical algorithm is launched and ends up with the list of cash-flows after having shown each intermediary step:

The first step for each section is: question mark “?”

The next step is: answer to the question mark (can we redeem some?)

Final step: end point: finished.

The algorithm recursively scans each GRP from top left to bottom right in order to span and scan the future of the investment date trying out all the redemption opportunities (rights) defined in the GRP against all the constraints. The algorithm stops when redemption of 100% of rights has been achieved or when it has tested the exact same proposition for a second time (which would mean an infinite loop). When more than one GRP are competing, each GRP ends up offering a redemption opportunity. These opportunities are valued according to the user preference (speed to cash or cheapest to cash).

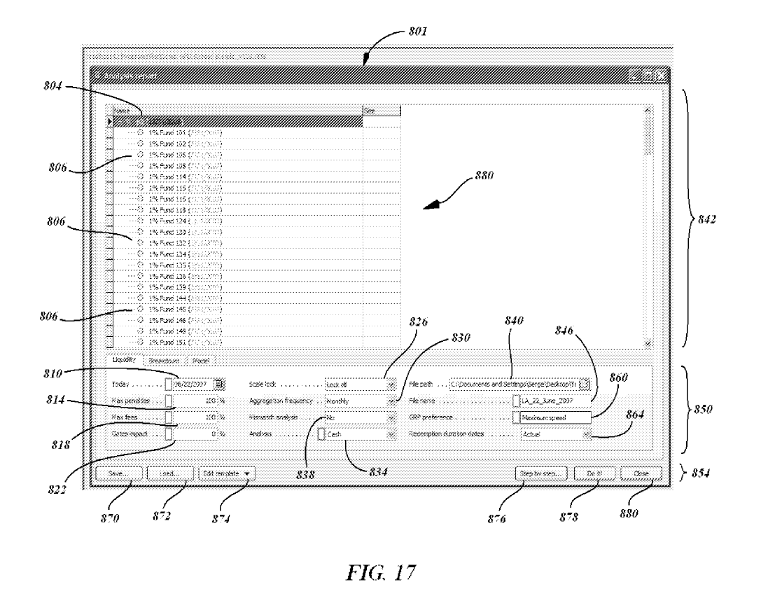

FIG. 17 illustrates a GUI “Analysis report” window 801, which makes it possible to launch a liquidity analysis on one or many portfolios of a fund of funds. The grid 880 is listing the portfolios selected by user through various possible means (like drag & drop for example). Any portfolio 804 in this grid can be opened for details 806 which show every component and its relative weights in the portfolio. The analysis will be launch by clicking on the “Do it” button 878 to create an XL spreadsheet with the indicated name 860 on the path 840 chosen by the user.

Two types of analysis are provided as example of the utilization of the present GRP approach: The field Analysis 834 offers “Cash” or “Market” analyses. The “Cash” analysis is forecasting all the cash flows that a portfolio will received when triggering the redemption of ALL positions at the date of Today 810. The “Market” analysis is forecasting all the investments that stop being exposed to the markets (i.e., when redeeming a fund when the NAV date of any total or partial redemption, the value of this investment is frozen at the NAV of this date, but the corresponding money will be paid later after the price it self (NAV) is known final and even in some cases audited).

As hedge funds offer various conditioned opportunities to redeem, these opportunities are ceased depending upon the rule that an investor/portfolio manager has decided to follow: Parameter “Max penalties” 814 defines the threshold of exit fees that any opportunity to redeem should be tested against to decide to use it or not. Parameter “Max fees” 818 has a similar impact when redemption rights are conditioned by such fees. Redemption rights are sometime also conditioned by gates which are more complex to integrate to the analysis as the amount redeemed to any given investor is depending on the behavior of all investor. So Parameter “Gates impact” 822 makes it possible to define what we anticipate as the impact of gates on the redemption process. For example, this impact can be a linear one between 0% where the investor has redeemed all its investment and 100% where the investor receives the percentage of the gate applied to his investment. Sometimes, the investor can be offered more than one option to redeem at the same time. So Parameter GRP preference 860 is used to define whether the investor wants it money at any cost (Maximum speed) or at the minimum cost (longest delay to cash or market exit). Parameter Mismatch analysis 838 make it possible to mirror a portfolio to a fund as the assets and liability of a balance sheet to analyze when the assets are less liquid that the liability. The other parameters that are not directly related with the details of the analysis can increase the ergonomy of the system.

The Step-by-step button opens another form (see FIGS. 15A through C) which makes it possible (as explained elsewhere) to see at all the details of the calculation of each analysis of each position in any given portfolio and check that the system making the right choice.

The aggregation process that takes place during the analysis is not in any way new, but follows basic principle of accounting and is obvious to one of ordinary skill in the art. A key innovation here is the absolute precision in forecasting both cash flows and/or divestments for each fund AND the ability to do so for any hedge fund known today.

Analysis: Summary Graph

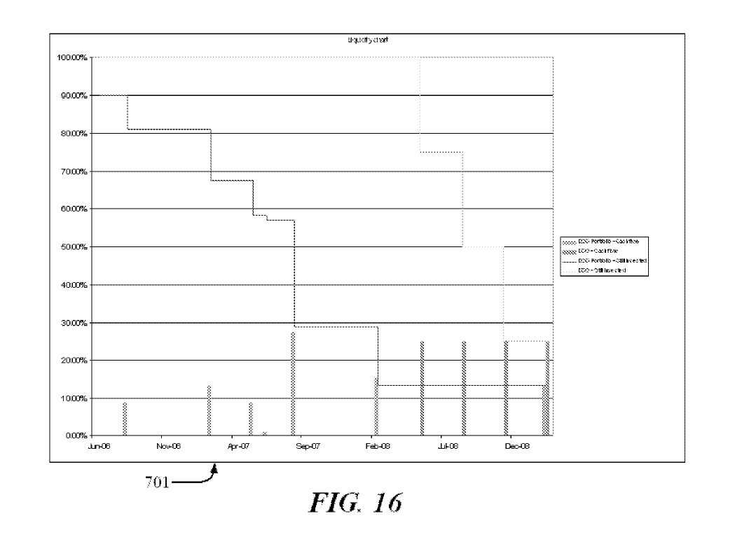

FIG. 16 is a graphical presentation summarizing a liquidity analysis. It is showing the example of a fund of funds (liability side of the balance sheet) and its portfolio (asset side of the balance sheet). The vertical bars represent the monthly cash-flow aggregated over all the positions and the lines are the remaining illiquid portions on both sides.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A hedge fund liquidity and redemption management system for processing and converting complex and diverse unstructured fund redemption related data and outputting processed data in a generic structure that is easy to mentally digest, the system comprising:
a data processor system receiving raw data input from via an I/O port and outputting generic structured data;
a generic redemption plan instruction set accessible by and in communication with the processor and including instructions for processing and converting complex and diverse unstructured fund redemption related raw data to generic, structured data; and
an output device in communication with the processor system via an I/O port, the output device presenting the generic, structured data to a user.

2. A hedge fund management system for processing complex, diverse and unstructured fund liquidity and redemption related data into an organized data structure database compatible with a presentation in a generic output structure format that is easily digested and manipulated, the system comprising:
a computer system having data input and output means;
a generic redemption plan instruction set resident in a first data storage media, the instruction set accessible by and in process communication with the computer system, the instruction set adapted to enable the computer system to receive and to process said diverse and unstructured fund liquidity and redemption related data into processed fund data, to store the processed fund data in a fund management system database, to selectively communicate the processed fund data to said generic output structure format in response to management parameter selections input by a user;
a management system database resident in a second data storage media accessible by and in functional communication with the computer system, the management system database for storing the processed fund data for use; and
an output device in functional communication with the computer system, the output device receiving and presenting the selectively communicated processed fund data in said generic structure format to the user.

3. The hedge fund management system of claim 2, wherein the computer system is any data processing system including a data processing system selected from the group consisting of: a computer system personally useable by the user, a workstation connected to a served network, and workstation connected to a mainframe computer system.

4. The hedge fund management system of claim 2, wherein the first and the second storage media are the same media.

5. The hedge fund management system of claim 2, wherein the computer system includes an input mechanism to receive the raw data input and a management parameter selection mechanism comprising a graphic user interface (GUI) display on the output device.

6. The hedge fund management system of claim 5, wherein the computer system includes an input mechanism to receive the raw data input is selected from the group of computer system input mechanisms consisting of: a Human-Computer Interface device, a data storage device, and a data port.

7. The hedge fund management system of claim 2, wherein the generic redemption plan instruction set further comprises the instruction set including instructions for a fund generic redemption plan application executable on the computer system to provide a system of hierarchically inter-related GUIs as a management parameter selection mechanism for input of management parameter selections.

8. The hedge fund management system of claim 2, wherein the generic redemption plan instruction set further comprises the instruction set including instructions for a fund generic redemption plan application executable on the computer system to provide a system of hierarchically inter-related GUIs as a manual raw data input means.

9. The hedge fund management system of claim 2, wherein the generic redemption plan instruction set further comprises the instruction set including instructions for a fund generic redemption plan application executable on the computer system to provide a system of hierarchically inter-related GUIs defining the generic data structure format.

10. The hedge fund management system of claim 2, wherein the generic redemption plan instruction set further comprises the instruction set including instructions for a fund generic redemption plan application executable on the computer system to provide a system of hierarchically inter-related GUIs defining the generic data structure format, and the output device receiving and presenting the selectively communicated processed fund data in said generic structure format to the user.

11. A management process for restructuring complex, diverse and unstructured raw hedge fund liquidity and redemption data for presentation and manipulation via a generic redemption data format, the management process comprising the steps of:
running a fund generic redemption plan application on a computer system having data input and output means;
inputting said raw fund liquidity and redemption data for processing by the generic redemption plan application via a data input means, and storing the raw data in a management system database on a data storage media in operative communication with the computer system;
restructuring the raw fund liquidity and redemption data in a process of the of the generic redemption plan application and storing the processed restructured fund data in the management system database;
selectively communicating the processed fund data to a generic output structure format for presentation on the output means, the output means in functional communication with the computer system and receiving and presenting the selectively communicated processed fund data in the generic structure format, the selective communicating being in response to management parameter selections input by a user; and
selectively performing a redemption analysis process, the redemption analysis process performed using as factors data derived from the input of management parameter selections and providing an analysis result, the analysis result being communicated to the generic structure format and presented on the output means to the user.

12. The management process of claim 11, wherein the step of running the generic redemption plan application further comprises the process of establishing a system of hierarchically inter-related GUIs defining generic data structure formats and providing:
a raw data input interface for the input of raw data;
a management parameter selection interface for input of management parameter selections;
an analysis function selection interface for selection and initiation of a redemption analysis process; and
an output presentation interface for presenting the selectively communicated processed fund data and in the generic structure format.

13. The management process of claim 11, wherein the step of inputting said raw fund liquidity and redemption data into the generic redemption plan application is accomplished via a data input means selected from the group of input means consisting of: a manual user interface means and an electronic interface means.

14. The management process of claim 11, wherein the step of restructuring the raw fund liquidity and redemption data further comprises the process of:
assessing an initial parameter of a fund raw data element; and
converting the initial parameter to a processed parameter to provide a fund restructured data element having a processed parameter compatible for input into the management system database; and
storing the processed restructured fund data element in the management system database.

15. The management process of claim 11, wherein the step of selectively communicating the processed fund data to a generic output structure format further comprises the process of:
presenting a selection of processed fund data to the user;
receiving an indication of a selected fund data from the user of a fund management parameter selection; and
communicating the selected fund data to said generic output structure format in the response to management parameter selection input by the user.

16. The management process of claim 15, wherein the step of selectively communicating the processed fund data to a generic output structure format for presentation is via an output means selected from the group of output means consisting of: a video display, a video monitor, a video projector, a printer, and a data storage device.
